(19) United States
(12) Patent Application Publication
(10) Pub. No.: US 2015/0379310 A1
(43) Pub. Date: Dec. 31, 2015

(54) Electronic Apparatus, Control Method and Storage Medium

(71) Applicant: Kabushiki Kaisha Toshiba, Tokyo (JP)

(72) Inventors: Masaaki Ikuta, Hamura (JP); Hideyuki Umedu, Hachioji (JP); Tadashi Tsuji, Mitaka (JP)

(21) Appl. No.: 14/574,098

(22) Filed: Dec. 17, 2014

Related U.S. Application Data
(60) Provisional application No. 62/018,412, filed on Jun. 27, 2014.

(51) Int. Cl. G06F 21/88; G06F 9/44

(52) U.S. Cl. CPC G06F 21/88; G06F 9/4416

(57) ABSTRACT

According to one embodiment, an electronic apparatus includes a first determination controller, a second determination controller and a security controller. The first determination controller determines, at intervals of a first time period, whether or not communication with a management server is executable. The second determination controller determines, when it is determined that the communication with the management server is not executable, whether or not a second time period elapses from a last one of times at each of which it is determined that the communication with the management server is executable. The security controller executes a process for inhibiting use of the apparatus when it is determined that the second time period elapses.

### CROSS-REFERENCE TO RELATED APPLICATIONS

This application claims the benefit of U.S. Provisional Application No. 62/018,412, filed Jun. 27, 2014, the entire contents of which are incorporated herein by reference.

### FIELD

Embodiments described herein relate generally to an electronic apparatus, a control method and a storage medium.

### BACKGROUND

In recent years, electronic apparatuses referred to as, e.g., tablets, which allow touch input to be performed on their displays have widely been used. As the tables have high portability, they can be considered to be rented to visitors at, for example, an exhibition or an art installation, in order for the visitors to view material concerning exhibits. If they are used in such a manner, it is not necessary to give the visitors material formed of paper, thus reducing the cost. In addition, by requesting the visitors to respond to questionnaires with the tablets, it is possible to efficiently summarize questionnaire results.

On the other hand, it is necessary to sufficiently consider a theft-prevention measure for preventing a rented tablet from being taken away.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing a form of use of an electronic apparatus according to an embodiment.

FIG. 2 is an exemplary view showing a system configuration of the electronic apparatus according to the embodiment.

FIG. 3 is an exemplary timing chart for explaining a basic principle of a theft-prevention measure with respect to the electronic apparatus according to the embodiment.

FIG. 4 is an exemplary flowchart showing an operation procedure at the time of powering up the electronic apparatus according to the embodiment.

FIG. 5 is an exemplary flowchart showing an operation procedure during a running of the electronic apparatus according to the embodiment.

### DETAILED DESCRIPTION

Various embodiments will be described hereinafter with reference to the accompanying drawings.

In general, according to one embodiment, an electronic apparatus comprises a communicator, a first determination controller, a second determination controller and a security controller. The first determination controller determines, at intervals of a first time period, whether or not communication with a management server is executable, by communicating with the management server, using the communicator. The second determination controller determines, when it is determined that the communication with the management server is not executable, whether or not a second time period elapses from a last one of times at each of which it is determined that the communication with the management server is executable. The security controller executes a process for inhibiting use of apparatus when it is determined that the second time period elapses.

FIG. 1 is an exemplary view showing a form of use of an electronic apparatus according to the embodiment. The electronic apparatus 1 is provided as a tablet 1. For example, it is planned that the tablet 1 will be provided as rental products, and for example, will be rented to visitors at, e.g., an exhibition or an art installation in order for them to view material concerning exhibits. On the tablet 1, software is installed to enable it to display, for example, documents (including images) or moving images for explaining exhibits at the exhibition, the art installation or the like. The software is an application program that runs on an operating system.

When not being rented out, the tablet 1 is accommodated in a cradle 2. The tablet 1 includes connector to be connected to the cradle 2 when being accommodated in the cradle 2. In this case, suppose the connector is, e.g., a USB connector. In other words, the cradle 2 includes connector portions to be connected to the USB connectors of the tablets 1 when they are accommodated in the cradle 2.

The cradle 2 is connected to a management server 3. Also, the cradle 2 functions as a bridge device which relays communication between the management server 3 and the tablet 1 accommodated. That is, the tablet 1 can communicate with the management server 3 (through the USB connector) only when being accommodated in the cradle 2. Although it is shown by way of example that the cradle 2 and the management server 3 are connected to each other by a cable, it may be set that for example, the cradle 2 is made to have a function of carry out communication through the Internet, and the cradle 2 and the management server 3 are connected together through the Internet.

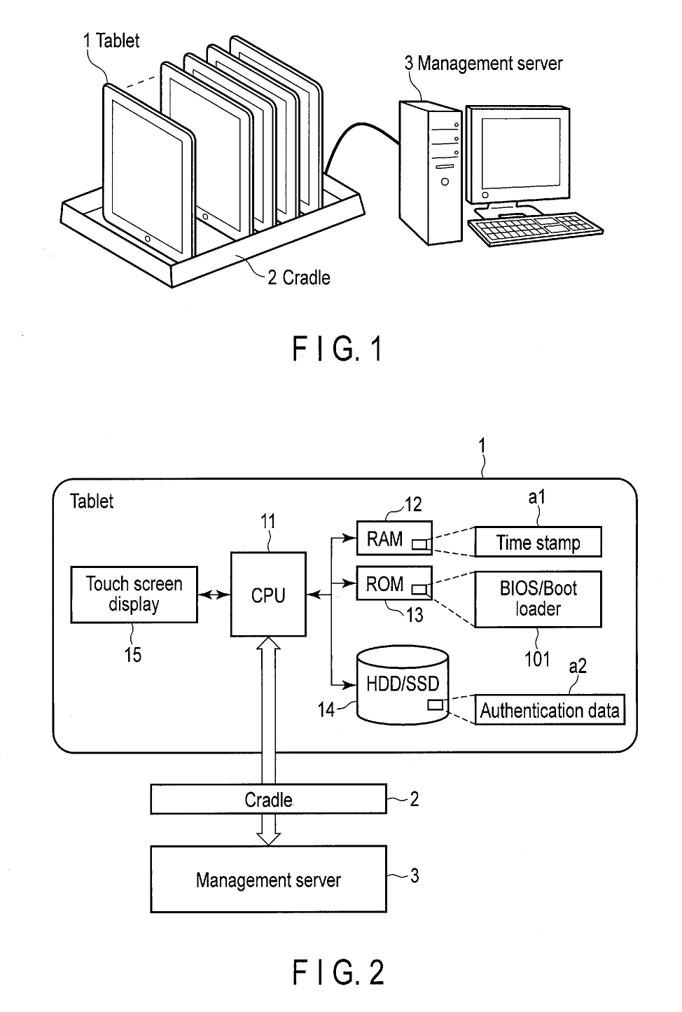

FIG. 2 is an exemplary view showing a system configuration of the tablet 1.

As shown in FIG. 2, the tablet 1 comprises a CPU 11, a RAM 12, a ROM 13, a HDD or SSD 14, a touch screen display 15, etc.

The CPU 11 is a processor which controls various kinds of components in the tablet 1. When the tablet 1 is powered up, the CPU 11 executes a BIOS or boot loader 101 stored in the ROM 13. The BIOS or boot loader 101 is a program which loads an OS stored in the HDD or SSD 14 into the RAM 12 serving as a main memory, and includes a security function which enables an OS to be loaded as long as authorized authentication data a2 is present in the HDD or SSD 14. Therefore, even if someone renting the tablet 1 takes it away, and installs an OS on it, he or she is not permitted to load or start the OS without the authorized authentication data a2.

Furthermore, as one of security functions, the BIOS or boot loader 101 includes a function of communicating with the management server 3 at the time of powering up the tablet 1 and at regular intervals, and records in the RAM 12, as a time stamp a1, the time at which it communicates with the management server 3. Furthermore, using the time stamp a1, the BIOS or boot loader 101 determines whether the tablet 1 can be used or not, and also includes a function of inhibiting the tablet 1 from being used, when determining whether the tablet 1 cannot be used. A basic principle of a theft-prevention measure using the time stamp a1 will be described later.

After the OS is booted, for example, in accordance with a touch input on the touch screen display 15, the CPU 11 loads an application program stored in the HDD or SSD 14 into the RAM 12, and executes the application program. The application program includes software for displaying a document (including an image) or moving images for explaining the exhibits in the exhibition or art installation.

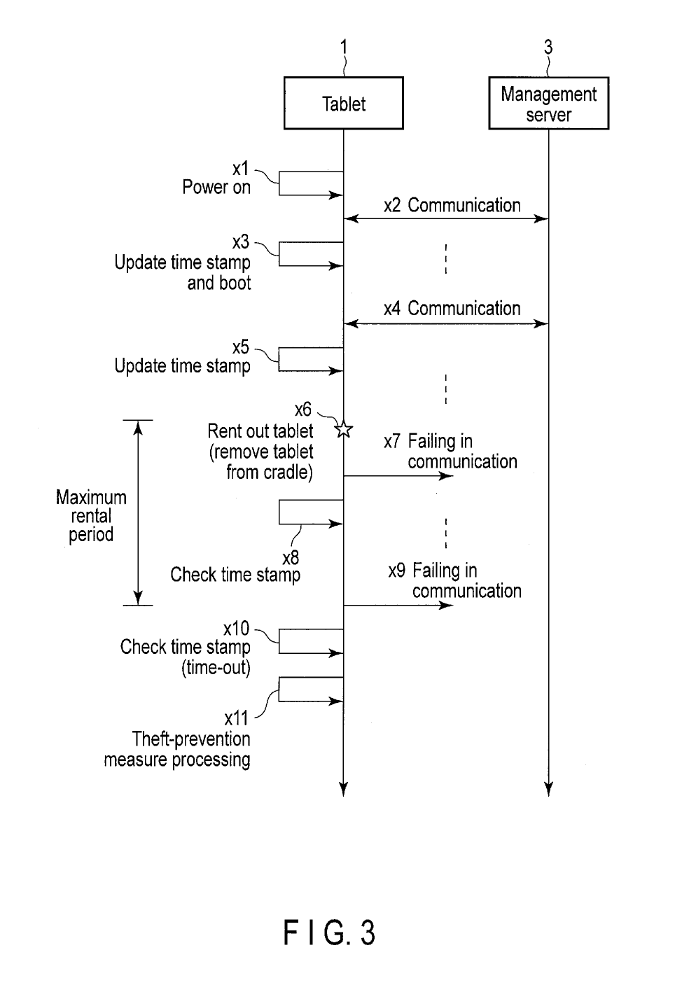

FIG. 3 is an exemplary timing chart for explaining a basic principle of a theft-prevention measure with respect to the tablet 1.

Suppose the tablet 1 is now accommodated in the cradle 2 and is also powered up (x1 in FIG. 3). When it is powered up, the BIOS or boot loader 101 executes communication (including authentication) with the management server 3 (x2 in FIG. 3). In this case, the RAM 12 is used as a work memory, and thus temporary server-authentication data xx is stored in the RAM 12. It should be noted that the temporary server-authentication data xx is data which is produced when authentication with the management server 3 is performed. Also, the temporary server-authentication data xx and the authentication data a2 are provided independent of each other.

When succeeding in communicating with the management server 3, the BIOS or boot loader 101 updates the time stamp a1, and loads the OS from the HDD or SSD 14 into the RAM 12 and boots the OS (x3 in FIG. 3). Thereafter, the BIOS or boot loader 101 executes communication with the management server 3 at regular intervals (x4 in FIG. 3), and if succeeding in the communication, it updates the time stamp a1 (x5 in FIG. 3).

Then, suppose the tablet 1 is removed from the cradle 2, and is rented out (x6 in FIG. 3). In this case, communication with the management server 3 which is executed by the BIOS or boot loader 101 at regular intervals fails (x7 in FIG. 3). When the communication fails, the BIOS or boot loader 101 checks the time stamp a1, and determines whether time elapsing from time indicated by the time stamp a1 exceeds a maximum rental period or not (x8 in FIG. 3). If the elapsed time does not exceed the maximum rental period, the BIOS or boot loader 101 performs no operation, and then after elapse of a given time, executes communication with the management server 3. It should be noted that it will hereinafter also be referred to as time-out that time elapsing from the time indicated by the time stamp a1 exceeds the maximum rental period.

On the other hand, in the case where the communication with the management server 3 fails (x9 in FIG. 3), and the time elapsing from the time indicated by the time stamp a1 exceeds the maximum rental period (x10 in FIG. 3), the BIOS or boot loader 101 executes a theft-prevention measure processing on the assumption that the tablet 1 is taken away (x11 in FIG. 3). The theft-prevention measure processing includes, for example, (a) inhibition of loading and booting of an OS, (b) initialization of the RAM 12 (including erasure of the temporary server-authentication data xx) and (c) power off. In the embodiment, the BIOS or boot loader 101 is configured to inhibit loading/booting of an OS in the case where a time-out occurs in the communication with the management server 3. By erasing the temporary authentication data xx, it is possible to prevent an attack on an authentication step with the server, which is made by analyzing content in the RAM 12 from the outside of the tablet 1. Furthermore, even if an OS is re-installed, since the authentication data a2 is overwritten, the OS can be prevented from being loaded and booted. It is also possible to prevent the tablet 1 from being taken away, by indicating at the time of renting out the tablet 1, that the tablet 1 becomes unusable if time for which the tablet 1 is rented exceeds the maximum rental period.

While the tablet 1 is accommodated in the cradle 2, the communication of the BIOS or boot loader 101 with the management server 3 succeeds, and the time stamp a1 is continuously updated. The time indicated by the time stamp a1 can be made closer to time at which the table 1 is removed from the cradle 2, by recording as the time stamp a1, the last one of times at each of which the communication with the management server 3 succeeds. An interval between the time indicated by the time stamp a1 and the above last time is smaller than each of regular intervals in which the BIOS or boot loader 101 communicates with the management server 3. Thus, time corresponding to each of the regular intervals may be added as a margin to the maximum rental period.

In the case where time at which the tablet 1 is powered up is recorded as the time stamp a1, it must be powered up each time it is rented out. On the other hand, in the embodiment, at the time of renting out the tablet 1, it suffices that the tablet 1 powered up in advance is removed from the cradle 2. Furthermore, if the tablet 1 returned within a rental period is accommodated in the cradle 2, the time stamp a1 is updated, and thus the returned tablet 1 can also be applied as a tablet to be rented out subsequently.

It should be noted that the above explanation is given with respect to the case where the tablet 1 is powered up while being in an accommodated state in the cradle 2. Even in the case where the tablet 1 is powered up while it is located outside the cradle 2, if the time elapsing from the time indicated by the time stamp a1 does not exceed the maximum rental period, the BIOS or boot loader 101 loads an OS from the HDD or SSD 14 into the RAM 12, and the OS is booted. Therefore, during the rental period, the tablet 1 can be powered down and then re-powered up. The BIOS or boot loader 101 saves the time stamp a1 from the RAM 12 into the HDD or SSD 14 at an ordinary powering-down time, for example, at the time of powering down the tablet 1 by touch input on the touch screen display 15.

Furthermore, it may be set such that the BIOS or boot loader 101 acquires from the management server 3, at least one of the maximum rental period and a time period corresponding to each of regular intervals at which the BIOS or boot loader 101 communicates with the management server 3.

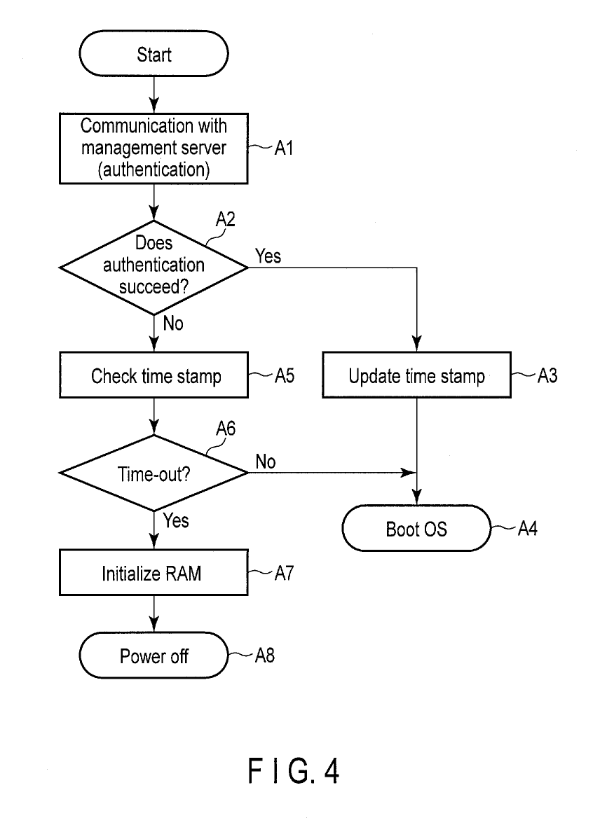

FIG. 4 is an exemplary flowchart showing an operation procedure at the time of powering up the tablet 1.

When the tablet 1 is powered up, the BIOS or boot loader 101 is booted, and the BIOS or boot loader 101 executes communication with the management server 3 (block A1). If the communication with the management server 3 succeeds (YES in block A2), the BIOS or boot loader 101 updates the time stamp a1 (Block A3), and loads an OS into the RAM 12, and the OS is booted (block A4).

On the other hand, when the communication with the management server 3 fails (NO in block A2), the BIOS or boot loader 101 checks the time stamp a1 (block A5) and determines whether a time-out occurs or not, i.e., whether the time elapsing from time indicated by the time stamp a1 exceeds the maximum rental period or not (block A6).

If a time-out does not occur (NO in block A6), the BIOS or boot loader 101 loads an OS into the RAM 12, and the OS is booted (block A4). On the other hand, if a time-out occurs (Yes in block A6), the BIOS or boot loader 101 performs initialization of the RAM 12 (including erasure of the temporary authentication data xx) (block A7), and powers down the tablet 1 (block A8).

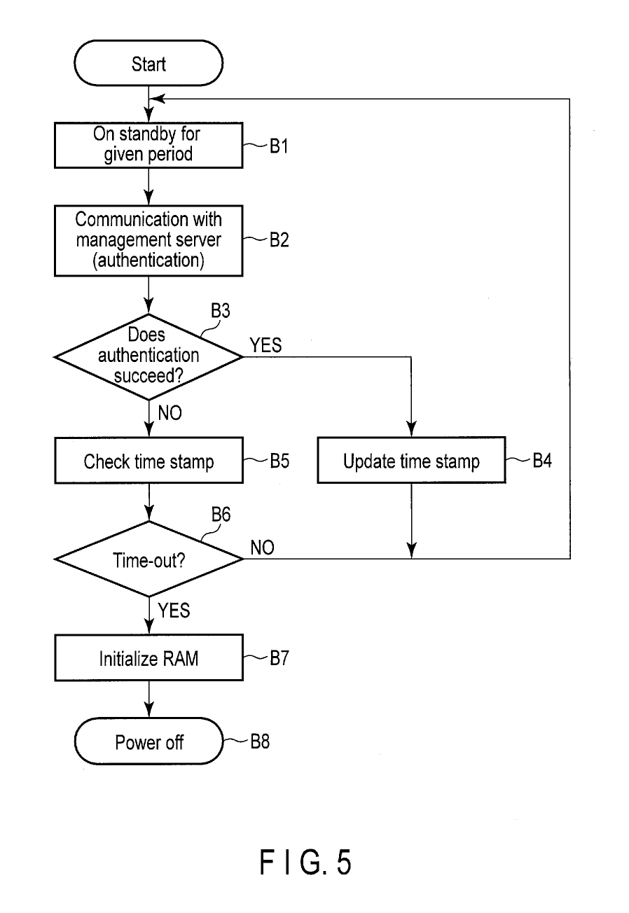

FIG. 5 is an exemplary flowchart showing an operation procedure during a running of the tablet 1.

After being on standby for a given time period (block B1), the BIOS or boot loader 101 executes communication with the management server 3 (block b2). If the communication with the management server 3 succeeds (YES in block B3), the BIOS or boot loader 101 updates the time stamp a1 (block B4), and returns to block B1.

On the other hand, if the communication with the management server 3 fails (NO in block B3), the BIOS or boot loader 101 checks the time stamp a1 (block B5), and determines whether a time-out occurs or not, i.e., time elapsing from time indicated by the time stamp a1 exceeds a maximum rental period or not (block B6)

If a time-out does not occur (No in block A6), the BIOS or boot loader 101 returns to block B1. On the other hand, if a time-out occurs (Yes in block B6), the BIOS or boot loader 101 performs initialization of the RAM 12 (including erasure of the temporary authentication data xx) (block B7), ant powers down the tablet 1 (block B8).

In such a manner, in the electronic apparatus 1 according to the embodiment, a theft-prevention measure for preventing a tablet rented out from being taken away is appropriately taken.

It should be noted that the above explanation is given with respect to an example in which if the communication with the management server 3 fails, the tablet 1 checks whether the time elapsing from the time indicated by the time stamp a1 exceeds the maximum rental period or not, and if the elapsed time exceeds the maximum rental period, the tablet 1 is made unusable. As a modification of the above example, it may be set that a timer which generates a time-out when the maximum rental period expires is provided, and is re-set each time the communication with the management server 3 succeeds, and the tablet 1 is made unusable if a time-out is generated.

Furthermore, it may be set that if time left before the time elapsing from the time indicated by the time stamp a1 exceeds the maximum rental period becomes equal to or smaller than a predetermined time, the touch screen display 15 is made to display an alarm message to the effect that for example, time by which the tablet 1 must be returned is pressing.

In addition, the above explanation is given with respect to an example in which the tablet 1 communicates with the management server 3 through the cradle 2. As a modification of the example, the tablet 1 may be set to wirelessly communicate with the management server 3. In such a modification, for example, the following setting can be achieved. If the management server 3 is disposed to enable the tablet 1 to communicate with the management server 3 only in the case where the tablet 1 is located in a predetermined place (it is not rented out), it is possible to cause the tablet 1 to fail to communicate with the management server 3 if the tablet 1 is rented out. Furthermore, one or more communication apparatuses are disposed to enable the tablet 1 to perform wireless communication only in the case where the tablet 1 is set to perform wireless communication and situated in a certain place such as an exhibition, an art installation or the like, and if a signal strength of wireless communication of the tablet 1 with said one or more communication apparatuses becomes equal to or less than a predetermined value, the touch screen display 15 is caused to display an alarm message for urging return of the tablet 1 on the assumption that it is located away from the above place.

The operation procedure according to each of the embodiments can be executed by software (program). Thus, it is possible to easily obtain the same advantages as in the embodiments, by executing the software after installing the software onto an ordinary computer through a computer-readable storage medium storing the software.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a communicator;
a first determination controller to determine, at intervals of a first time period, whether or not communication with a management server is executable, by communicating with the management server, using the communicator;
a second determination controller to determine, when it is determined that the communication with the management server is not executable, whether or not a second time period elapses from a last one of times at each of which it is determined that the communication with the management server is executable; and
a security controller to execute processing for inhibiting use of the apparatus when it is determined that the second time period elapses.

2. The apparatus of claim 1, wherein the security controller is provided as a function of a BIOS or a boot loader, and inhibits loading of an OS when it is determined that the second time period elapses.

3. The apparatus of claim 1, further comprising a connector to be connected to a cradle when the apparatus is accommodated in the cradle,
wherein the communicator communicates with the management server through the connector connected to the cradle.

4. The apparatus of claim 1, wherein the security controller initializes a main memory when it is determined that the second time period elapses.

5. The apparatus of claim 1, further comprising an acquisition controller to acquire at least one of information indicative of the first time period and information indicative of the second time period from the management server, by communication of the communicator.

6. The apparatus of claim 1, further comprising an alarm controller to output an alarm message if time left before the second time period elapses from the last one of the times at each of which it is determined that the communication with the management server is executable is a third time period or less.

7. The apparatus of claim 1, wherein:
the communicator executes wireless communication; and
the electronic apparatus further comprises an alarm controller to output an alarm message when a signal strength of the wireless communication executed by the communicator is equal to or less than a first value.

8. A control method for an electronic apparatus, the method comprising:
determining, at intervals of a first time period, whether or not communication with a management server is executable, by communicating with the management server, using a communicator;
determining, when it is determined that the communication with the management server is not executable, whether or not a second time period elapses from a last one of times at each of which it is determined that the communication with the management server is executable; and
executing processing for inhibiting use of the apparatus when it is determined that the second time period elapses.

9. The method of claim 8, wherein the executing the processing comprises inhibiting loading of an OS when it is determined that the second time period elapses.

10. The method of claim 8, wherein the executing the processing comprises initializing a main memory when it is determined that the second time period elapses.

11. The method of claim 8, further comprising acquiring at least one of information indicative of the first time period and information indicative of the second time period from the management server, by communication of a communicator.

12. The method of claim 8, further comprising outputting an alarm message if time left before the second time period elapses from the last one of the times at each of which it is determined that the communication with the management server is executable is a third time period or less.

13. The method of claim 8, further comprising outputting an alarm message when a signal strength of the wireless communication executed by the communicator is equal to or less than a first value.

14. A computer-readable, non-transitory storage medium having stored thereon a computer program which is executable by a computer, the computer program controlling the computer to function as:
a first determination controller to determine, at intervals of a first time period, whether or not communication with a management server is executable, by communicating with the management server, using a communicator;
a second determination controller to determine, when it is determined that the communication with the management server is not executable, whether or not a second time period elapses from a last one of times at each of which it is determined that the communication with the management server is executable; and
a security controller to execute processing for inhibiting use of the apparatus when it is determined that the second time period elapses.

15. The medium of claim 14, wherein the security controller is provided as a function of a BIOS or a boot loader, and inhibits loading of an OS when it is determined that the second time period elapses.

16. The medium of claim 14, wherein the security controller initializes a main memory when it is determined that the second time period elapses.

17. The medium of claim 14, wherein the program further causes the computer to function as an acquisition controller to acquire at least one of information indicative of the first time period and information indicative of the second time period from the management server, by communication of the communicator.

18. The medium of claim 14, wherein the program further causes the computer to function as an alarm controller to output an alarm message when time left before the second time period elapses from the last one of the times at each of which it is determined that the communication with the management server is executable is a third time period or less.

19. The medium of claim 14, wherein the program further causes the computer to function as an alarm controller to output an alarm message when a signal strength of wireless communication executed by the communication portion is equal to or less than a first value.
